(19) United States
(12) Patent Application Publication
(10) Pub. No.: US 2016/0032736 A1
(43) Pub. Date: Feb. 4, 2016

(54) COATING PROCESS AND COATED ARTICLE

(71) Applicant: GENERAL ELECTRIC COMPANY, Schenectady, NY (US)

(72) Inventors: Michael James HEALY, Greenville, SC (US); John Wesley HARRIS, JR., Taylors, SC (US)

(73) Assignee: GENERAL ELECTRIC COMPANY, Schenectady, NY (US)

(21) Appl. No.: 13/894,500

(22) Filed: May 15, 2013

(51) Int. Cl. F01D 5/28; F01D 5/22; F01D 25/24; F01D 5/30; C23C 28/00; F01D 9/02

(52) U.S. Cl. CPC F01D 5/288; C23C 28/3455; F01D 9/02; F01D 25/24; F01D 5/30; F01D 5/225; F05D 2220/30; F05D 2230/90; F05D 2230/10; F05D 2260/202; F05D 2300/437

(57) ABSTRACT

A coating process and coated article are provided. The coating process includes providing a turbine component, applying a coating repellant to a predetermined region of the turbine component, and depositing a coating material on the turbine component. The coating repellant directs the coating material away from the predetermined region of the turbine component, to at least partially form a channel. A coating process for a hot gas path turbine component and coated article are also disclosed.

### FIELD OF THE INVENTION

The present invention is directed to coating methods and coated articles for turbine components. More specifically, the present invention is directed to thermal barrier coating methods and thermal barrier coated articles for turbine component.

### BACKGROUND OF THE INVENTION

Temperature limitations of turbine component materials present a barrier to increasing turbine operation temperatures, and thus, turbine efficiency. Limitations on cooling capabilities of such turbine components is one feature that results in such temperature limitations. For example, a failure to adequately cool and/or operation at or above predetermined temperatures can translate into fatigue due to thermal expansion and contraction of the turbine components.

In addition, turbine components are subject to a temperature profile having a temperature gradient. The temperature profile and/or the temperature gradient can heat different portions of a turbine component at different rates, especially during start-up or shut-down of operation. Such uneven heating can result in low-cycle fatigue, which is undesirable because it decreases the overall useful life of the turbine component.

A formation of channels or trenches on a surface of the turbine component materials can provide additional cooling to the component. However, near-surface cooling channels can be difficult to form. Near-surface cooling channels can also form difficulties in repairing the turbine component. Additionally, a machining of trenches or channels extending through a coating to a base material can result in trenching and/or scarfing of a base metal. One method of forming trenches or channels extending through the coating to the base material includes using a water jet. Controlling the depth of the trench can be difficult with a water jet, often causing the trench to extend into the base material. Furthermore, machining of materials can result in undesirable features, such as, an inability to re-produce or repair components that have already been machined.

A turbine component coating process and a coated turbine component that do not suffer from one or more of the above drawbacks would be desirable in the art.

BRIEF DESCRIPTION OF THE INVENTION

In an exemplary embodiment, a coating process includes providing a turbine component, applying a coating repellant to a predetermined region of the turbine component, and depositing a coating material on the turbine component. The coating repellant directs the coating material away from the predetermined region of the turbine component, to at least partially form a channel.

In another exemplary embodiment, a coating process includes providing a hot gas path turbine component, applying an elongated strip of a coating repellant to a predetermined region of the hot gas path turbine component, depositing a coating material on the hot gas path turbine component, and removing the elongated strip of the coating repellant. The coating repellant directs the coating material away from the predetermined region of the hot gas path turbine component, forming a cooling channel in the hot gas path turbine component.

In another exemplary embodiment, a coated article includes a turbine component, a bond coat over the turbine component, a thermal barrier coating over the bond coat, and a channel through the thermal barrier coating and the bond coat. The channel is formed during an application of the bond coat and thermal barrier coating, the channel exposing a substrate surface of the turbine component.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a turbine bucket having coating repellant, according to an embodiment of the invention.

FIG. 2 is a perspective view of a turbine shroud having coating repellant, according to an embodiment of the invention.

FIG. 3 is a cross-sectional view of multiple coating repellant strips, according to an embodiment of the invention.

FIG. 4 is a cross-sectional view of a coating repellant strip, according to an embodiment of the invention.

FIG. 5 is a cross-sectional view of a coating repellant strip, according to an embodiment of the invention.

FIG. 6 is a cross-sectional view of a coating repellant strip, according to an embodiment of the invention

FIG. 7 is a cross-sectional view of a coating repellant strip, according to an embodiment of the invention.

FIG. 8 is a sectional view of a coating repellant in a channel, according to an embodiment of the invention.

FIG. 9 is a sectional view of a coating repellant in a channel, according to an embodiment of the invention.

FIG. 10 is a perspective view of a coating repellant in a channel, according to an embodiment of the invention.

Wherever possible, the same reference numbers will be used throughout the drawings to represent the same parts.

### DETAILED DESCRIPTION OF THE INVENTION

Provided is an exemplary turbine component coating method and coated turbine component. Embodiments of the present disclosure, in comparison to processes and articles not using one or more of the features disclosed herein, decrease trenching of a metal in a component, increase efficiency of channel formation, decrease cost of channel formation, increase control of channel formation, increase exposure of a substrate material, or a combination thereof.

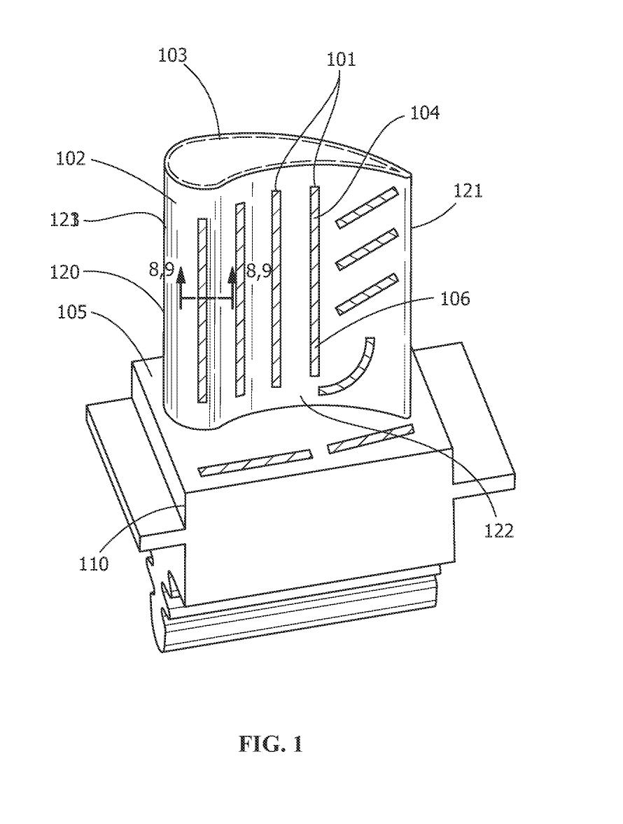

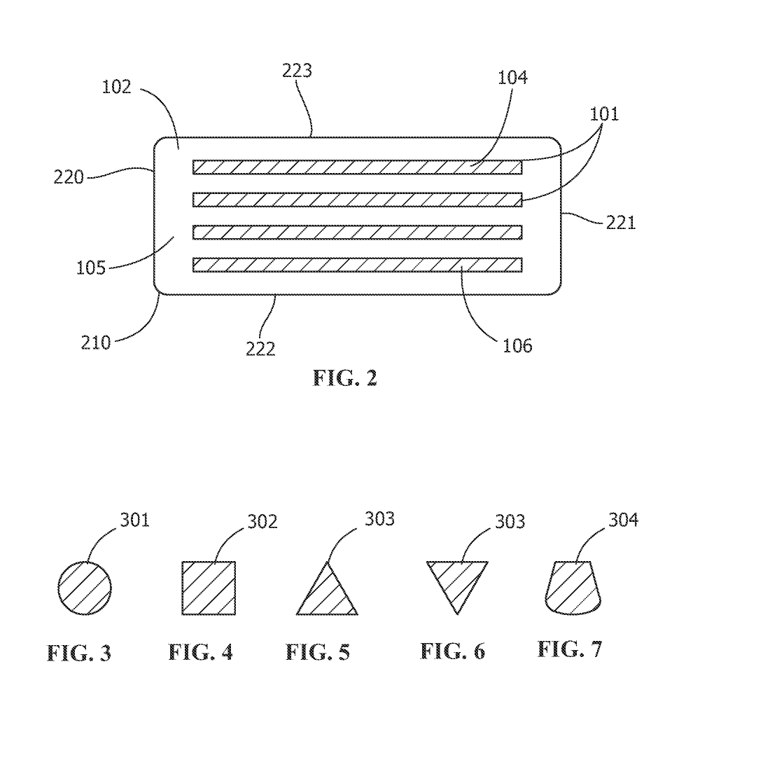

Referring to FIG. 1 and FIG. 2, a coating repellant 101 is applied to a predetermined region 104 of a turbine component 105. The predetermined region 104 includes a portion of a substrate surface 103. The substrate surface 103, as used herein, refers to an outermost face of the turbine component 105 prior to deposition of a coating material 102. The turbine component 105 is any suitable turbine component that includes film cooling, for example, a bucket (or blade), a nozzle, a shroud, a near flowpath seal, a sidewall, a dovetail, or a combination thereof. Suitable materials of the turbine component 105 include, but are not limited to, a ceramic matrix composite, an alloy, a directionally solidified metal, a single crystal metal, an equiaxed grain metal, other suitable metal compositions, or a combination thereof

Referring to FIG. 1, in one embodiment, the turbine component 105 is a hot gas path component such as, but not limited to, a bucket 110 (or blade), a nozzle, or a combination thereof. A suitable position for the predetermined region 104 of the turbine component 105, includes, but is not limited to, a suction side 123, a pressure side 122, a leading edge 120, a trailing edge 121, a sidewall, a platform, or a combination thereof

Referring to FIG. 2, in one embodiment, the turbine component 105 is a gas turbine component such as, but not limited to, a shroud 210. The shroud 210 includes at least a tip portion 220, a rear portion 221, a first edge 222, and a second edge 223.

Referring to FIG. 1 and FIG. 2, the coating material 102 is deposited on the turbine component 105. The coating repellant 101 directs the coating material 102 away from the predetermined region 104, forming a channel 106 in the turbine component 105. The channel 106 extends through the coating material 102 to the substrate surface 103. Removal of the coating repellant 101 exposes the channel 106. In one embodiment, the predetermined region 104 includes a pre-formed channel in the substrate surface 103 of the turbine component 105.

In one embodiment, cooling holes are machined in the substrate surface 103 exposed by the channel 106 after the coating repellant 101 has been removed. In one embodiment, the cooling holes are machined in the substrate surface 103, then covered by the coating repellant 101. The cooling holes are machined using any suitable machining method including, but not limited to, water jet machining, electrical discharge machining (EDM), electrochemical machining (ECM), laser drilling, or a combination thereof. In one embodiment, the coating repellant 101 is used for masking of the turbine component 105.

Referring to FIG. 3, FIG. 4, FIG. 5, FIG. 6, and FIG. 7, suitable geometries of the coating repellant 101 include, but are not limited to, elongated strips having geometric profiles resembling a rectangle, a circle 301, a square 302, a triangle 303, an octagon, a quadrilateral 304, or a combination thereof. The elongated strips of the coating repellant 101 are applied in the predetermined region 104, over a length of the substrate surface 103. Suitable structure of the coating repellant 101 includes, but is not limited to, rigid, flexible, twisted, curved, straight, dashed (for example interrupted/broken segments), or a combination thereof

In one embodiment, the coating repellant 101 is a pre-formed material such as a wire, tube, strip, strand, plate, or combination thereof. The coating repellant 101 is attached to or rests on the substrate surface 103. Controlling a size and/or shape of the coating repellant 101 provides increased control over a depth of the channel 106. In one embodiment, the coating repellant 101 is applied to the predetermined regions 104 of the turbine component 105 and cured. Suitable curing methods of the coating repellant 101 include, but are not limited to, thermal, radiation such as electron beam (EB) or ultraviolet (UV), catalyst, or a combination thereof. In one embodiment, thermal curing includes heating the coating repellant 101 at 250° F. for 30 minutes. In general, suitable thermal curing temperatures include, but are not limited to, between about 100° F. and about 400° F., between about 150° F. and about 350° F., between about 200° F. and about 400° F., between about 200° F. and about 300° F., between about 225° F. and about 275° F., or any combination, sub-combination, range, or sub-range thereof. Suitable thermal curing durations include, but are not limited to, between about 10 minutes and about 60 minutes, between about 10 minutes and about 50 minutes, between about 20 minutes and about 40 minutes, between about 25 minutes and about 35 minutes, or any combination, sub-combination, range, or sub-range thereof.

The coating repellant 101 includes any material suitable for repelling the coating material 102. Suitable materials for the coating repellant 101 include, but are not limited to, elastomers, silicon-based compounds, or a combination thereof. One suitable material has a composition of between about 20% and about 30% methyl vinyl/di-methyl vinyl/vinyl terminated siloxane, between about 20% and about 30% vinyl silicone fluid, between about 15% and about 30% ground silica, between about 3% and about 9% silanol terminated PDMS, up to about 0.5% sodium alumino sulphosilicate, up to about 1% vinyl-tris(2-methoxy ethoxy)silane, up to about 1% titanium dioxide, up to about 2% precipitated silica, up to about 1% stoddard solvent, up to about 0.5% neodecanoic acid, rare earth salts, up to about 0.5% rare earth 2-ethylhexanoate, and up to about 0.2% magnesium ferrite.

After curing, the coating repellant 101 is maintained in position until the coating repellant 101 is removed. In one embodiment, the coating repellant 101 is thermally or chemically removed using mechanisms including, but not limited to, leaching agents, releasing agents, releasing gels, solvents, heat, or combinations thereof. In one embodiment, the coating repellant 101 is partially or completely vaporized during deposition of the coating material 102, such that at least a portion of the coating repellant is removed upon completion of the deposition. Removing the coating repellant 101 opens the channel 106 and exposes the substrate surface 103 without scarfing or cutting the substrate surface 103. After removing the coating repellant 101, the channel 106 permits cooling to the turbine component 105, such as micro-channel cooling, near-wall cooling, and/or film cooling.

In one embodiment, the coating material 102 includes one or more bond coat 402 layer(s) and one or more thermal barrier coating (TBC) 401 layer(s). Directing away of the bond coat 402 and/or the TBC 401 at least partially forms the channel 106 as the coating material 102 is deposited. Referring to FIG. 8 (section A-A of FIG. 1), in one embodiment, the coating repellant 101 extends away from the substrate surface 103, forming a protruding portion 801. The protruding portion 801 facilitates the removal of the coating repellant 101 by providing an increased area for physically grasping the coating repellant 101.

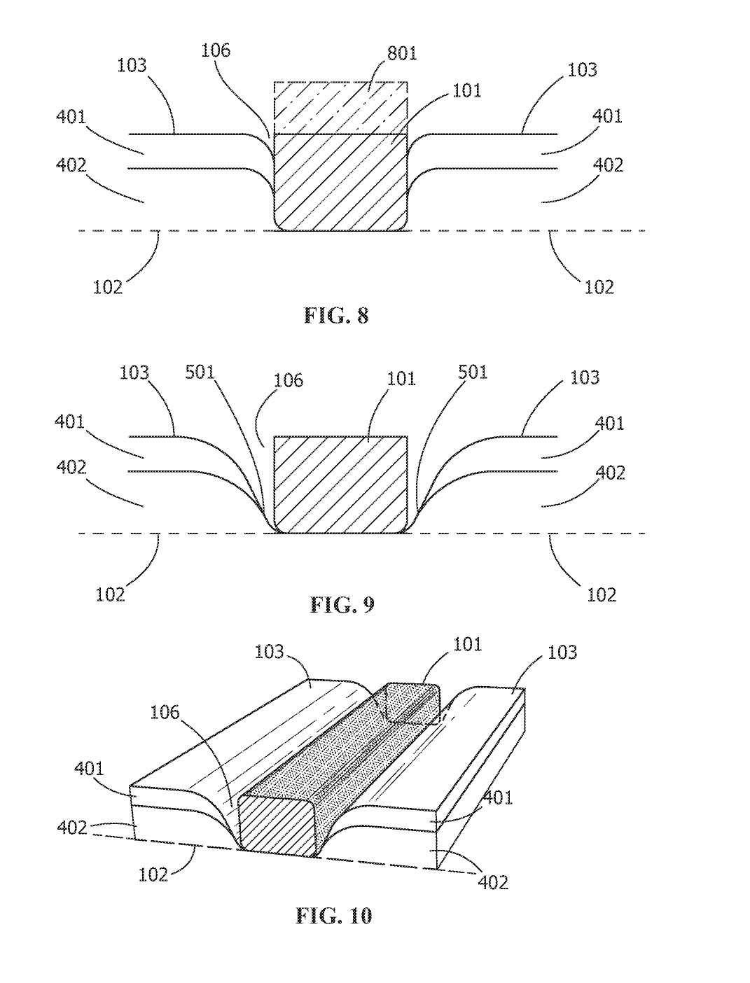

Referring to FIG. 9 (section A-A of FIG. 1), in one embodiment, the coating repellant 101 is substantially level with the coating material 102. An exposed portion 501 of the bond coat 402 is formed from the directing away of the TBC 401 from the coating repellant 101. In another embodiment, the exposed portion 501 of the bond coat 402 is covered by additional TBC 401 deposition. Covering the exposed portion 501 of the bond coat 402 decreases wear and/or degradation of the bond coat 402 during use of the turbine component 105. Additionally, the shape, geometry, position, orientation, size, length, thickness, diameter, or combination thereof of the coating repellant 101 provides a shape of the channel 106. See, for example, FIG. 10.

In one embodiment, the bond coat 402 is deposited on the substrate surface 103 of the turbine component 105 while being directed away from the coating repellant 101. In one embodiment, the TBC 401 is deposited and the bond coat 402 is not deposited on the substrate surface 103 of the turbine component 105. Suitable compositions of the bond coat 402 include, but are not limited to, FeCrAlY, CoCrAlY, NiCrAlY, or a combination thereof

In one embodiment, the TBC 401 is deposited on the bond coat 402 while being directed away from the coating repellant 101. In one embodiment, the bond coat 402 is deposited and the TBC 401 is not deposited on the substrate surface 103 of the turbine component 105. Suitable compositions of the TBC 401 include, but are not limited to, Y₂O₃ stabilized ZrO₂, any yttria stabilized zirconia, or a combination thereof.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A coating process, comprising:
providing a turbine component;
applying a coating repellant to a predetermined region of the turbine component; and
depositing a coating material on the turbine component;
wherein the coating repellant directs the coating material away from the predetermined region of the turbine component, to at least partially form a channel.

2. The coating process of claim 1, wherein the coating repellant is an elastomer, a silicon-based compound, or a combination thereof.

3. The coating process of claim 1, wherein the coating material is a bond coat, a thermal barrier coating, or a combination thereof.

4. The coating process of claim 1, wherein the predetermined region of the turbine component comprises a pre-formed channel.

5. The coating process of claim 1, further comprising a removing of the coating repellant from the predetermined region of the turbine component.

6. The coating process of claim 5, further comprising the removing of the coating repellant with a leaching agent.

7. The coating process of claim 5, further comprising the removing of the coating repellant with a releasing agent.

8. The coating process of claim 5, further comprising the removing of the coating repellant with heat.

9. The coating process of claim 5, wherein the removing of the coating repellant exposes a substrate surface.

10. The coating process of claim 1, further comprising machining cooling holes in the exposed substrate surface within the channel.

11. The coating process of claim 1, wherein the depositing the coating material is on an exposed portion of the bond coat.

12. The coating process of claim 1, wherein the turbine component is a shroud.

13. The coating process of claim 1, wherein the turbine component is a hot gas path turbine component.

14. The coating process of claim 13, wherein the hot gas path turbine component is a bucket.

15. The coating process of claim 13, wherein the hot gas path turbine component is a nozzle.

16. The coated article of claim 1, wherein the turbine component comprises an alloy.

17. The coated article of claim 1, wherein the turbine component comprises a metal.

18. The coated article of claim 1, wherein the turbine component comprises a ceramic matrix composite.

19. A coating process, comprising:
providing a hot gas path turbine component;
applying an elongated strip of a coating repellant to a predetermined region of the hot gas path turbine component;
depositing a coating material on the hot gas path turbine component; and
removing the elongated strip of the coating repellant;
wherein, the coating repellant directs the coating material away from the predetermined region of the hot gas path turbine component, forming a cooling channel in the hot gas path turbine component.

20. A coated article, comprising:
a turbine component;
a bond coat over the turbine component;
a thermal barrier coating over the bond coat; and
a channel through the thermal barrier coating and the bond coat;
wherein, the channel is formed during an application of the bond coat and thermal barrier coating, the channel exposing a substrate surface of the turbine component.
